(19) United States
(12) Patent Application Publication
(10) Pub. No.: US 2022/0250452 A1
(43) Pub. Date: Aug. 11, 2022

(54) OPENING AND CLOSING MEMBER

(71) Applicant: HONDA MOTOR CO., LTD., Tokyo (JP)

(72) Inventors: Yoshinori MIYAKE, Tokyo (JP); Keisuke HAYASHI, Tokyo (JP); Kyosuke ICHINOHE, Tokyo (JP); Fumiyoshi MIZUTANI, Tokyo (JP)

(21) Appl. No.: 17/583,201

(22) Filed: Jan. 25, 2022

(30) Foreign Application Priority Data
Feb. 5, 2021 (CN) 202110164225.0

(51) Int. Cl. B60J 5/10

(52) U.S. Cl. CPC B60J 5/102; B60J 5/107

(57) ABSTRACT

An opening and closing member is attachable, in an openable and closable manner, to a rear opening of a vehicle body via a pair of hinges. The opening and closing member includes an outer panel and a reinforcing member. The outer panel and the reinforcing member form a window frame. The reinforcing member has closed section parts formed by an outer reinforcing member and an inner reinforcing member. The closed section parts have a pair of front-rear closed section parts that extend in a vehicle body front-rear direction, and a pair of inclined closed section parts that respectively extend from ends, located adjacent to a vehicle body front side, of the pair of front-rear closed section parts, and that respectively incline inwardly in the vehicle body width direction. Open section parts are respectively provided between the hinges and the front-rear closed section parts.

This application is based on and claims the benefit of priority from Chinese Patent Application No. 202110164225.0, riled on 5 Feb. 2021, the content of which is incorporated herein by reference.

### BACKGROUND OF THE INVENTION

### Field of the Invention

The present invention relates to an opening and closing member.

### Related Art

A known opening and closing member is provided with a reinforcing member that forms a closed cross section on a side, facing a vehicle body inner side, of an outer panel disposed to face a vehicle body outer side (e.g., see Japanese Unexamined Patent Application, Publication No. 2019-108017). The reinforcing member is formed into an annular shape to extend along the entirety of a window frame of the opening and closing member.

Patent Document 1: Japanese Unexamined Patent Application, Publication No. 2019-108017

### SUMMARY OF THE INVENTION

However, such an annular reinforcing member is also provided at positions where strength and stiffness are not ordinarily required, thereby increasing the weight and cost of an opening and closing member. Furthermore, such an annular reinforcing member may lead to low productivity because it is required to take into account positioning and dimension errors when it is attached to a side, facing a vehicle body inner side, of an outer panel.

An object of the present invention is to provide an opening and closing member that can ensure strength and stiffness required for the opening and closing member, while reducing the weight and cost.

A first aspect of the present invention is directed to an opening and closing member (e.g., a rear gate 1 described later) that is attachable, in an openable and closable manner, to a rear opening (e.g., a rear opening 101 described later) of a vehicle body (e.g., a vehicle body 100 described later) via a pair of hinges (e.g., hinges 102 described later). The opening and closing member includes: an outer panel (e.g., an outer panel 11 described later) disposed to face a vehicle body outer side; and a reinforcing member (e.g., reinforcing members 2 described later) disposed on a side, facing a vehicle body inner side, of the outer panel. The outer, panel and the reinforcing member form a window frame (e.g., a window frame 10 described later) extending along four sides. The reinforcing member has closed section parts (e.g., closed section parts 23 described later) each formed by an outer reinforcing member (e.g., an outer reinforcing member 21 described later) disposed to face the vehicle body outer side and an inner reinforcing member (e.g., an inner reinforcing member 22 described later) disposed to face the vehicle body inner side. The closed section parts have, on both sides in a vehicle body width direction, a pair of front-rear closed section parts (e.g., front-rear closed section parts 231 described later) extending in a vehicle body front-rear direction and a pair of inclined closed section parts (e.g., inclined closed section parts 232 described later) that respectively extend from ends (e.g., ends 231a described later), located adjacent to a vehicle body front side, of the pair of front-rear closed section parts, and that respectively incline inwardly in the vehicle body width direction. Open section parts (e.g., open section parts 24 described later) are respectively provided between the pair of hinges and the pair of front-rear closed section parts.

A second aspect is an embodiment of the first aspect. In the opening and closing member according to the second aspect, the open section parts may be disposed between inner ends (e.g., inner ends 232a described later), in the vehicle body width direction, of the pair of inclined closed section parts.

A third aspect is an embodiment of the first or second aspect. In the opening and closing member according to the third aspect, the pair of inclined closed section parts may respectively extend from ends, located adjacent to the vehicle body front side, of the pair of front-rear closed section parts to positions before a portion (e.g., a front end part 10c) forming part of the window frame and extending straight in the vehicle body width direction.

A fourth aspect is an embodiment of any one the first to third aspects. The opening and closing member according to the fourth aspect may further include a mid-panel (e.g., a mid-panel 12 described later) provided on a side, lying adjacent to a vehicle body rear side and facing the vehicle body inner side, of the outer panel. The mid-panel (e.g., ends 12a described later) may have portions located at corners (e.g., corners 10e) of the window frame that are adjacent to the vehicle body rear side.

A fifth aspect is an embodiment of any one of the first to fourth aspects. The opening and closing member according to the fifth aspect may further include cushioning members (e.g., cushioning members 3 described later) respectively provided at positions on outer sides, in the vehicle body width direction, of the pair of front-rear closed section parts, the positions corresponding to the corners of the window frame that are located adjacent to the vehicle body rear side. The cushioning members come into contact with parts on the vehicle body when the rear opening is closed.

A sixth aspect is an embodiment of any one of the first to fifth aspects. In the opening and closing member according to the sixth aspect, the pair of hinges may be respectively attached to ends (e.g., ends 22a described later), located adjacent to the vehicle body front side, of the inner reinforcing members.

According to the first aspect of the present invention, strength and stiffness of the opening and closing member are ensured not only due to the configuration in which the opening and closing member is attached to the vehicle body with the pair of hinges, but also due to the closed section parts formed by the front-rear closed section parts and the inclined closed section parts. Therefore, while strength and stiffness required for the opening and closing member can be ensured, the provision of the open section parts makes it possible to reduce an increase in the weight and cost of the opening and closing member.

According to the second aspect, the open section parts are disposed between the inner ends, in the vehicle body width direction, of the pair of inclined closed section parts, thereby making it possible to not only ensure the strength and stiffness required for the opening and closing member, but also utilize the open section parts to ensure an arrangement space for a member such as a harness in the opening and closing member.

The third aspect makes it possible to ensure the strength and stiffness of the corners, located adjacent to the vehicle body front side, of the window frame, which are likely to be subjected to stress when the opening and closing member is opened or closed.

The fourth aspect makes it possible to ensure the strength and stiffness of the corners, located adjacent to the vehicle body rear side, of the window frame, which are likely to be subjected to stress when the opening and closing member is opened or closed.

According to the fifth aspect, the cushioning members being provided to the front-rear closed section parts having high strength and stiffness make it possible to further ensure the strength and stiffness of the corners, located adjacent to the vehicle body rear side, of the window frame, which are likely to be subjected to stress when the opening and closing member is opened or closed.

According to the sixth aspect, attaching the hinges to the inner reinforcing members having high strength and stiffness makes it possible to reinforce the hinges. This feature allows the opening and closing member to be opened and closed smoothly, and makes it possible to enhance the durability of mechanical parts provided for the opening and closing.

### BRIEF DESCRIPTION OF THE DRAWINGS

FIG. 1 is a perspective view illustrating a rear of a vehicle body, to which an opening and closing member is attached;

FIG. 2 is a plan view illustrating the opening and closing member with an outer panel and a glass panel removed;

FIG. 3 is a plan view illustrating the opening and closing member with a top surface part of the outer panel, the glass panel, and an outer reinforcing member removed;

FIG. 4 is a cross-sectional view taken along line A-A in FXG. 2;

FIG. 5 is an enlarged view illustrating a hinge of the opening and closing member;

FIG. 6 is a side view of the rear of the vehicle body, illustrating a cushioning member of the opening and closing member; and

FIG. 7 is a cross-sectional view taken along line B-B in FIG. 1.

### DETAILED DESCRIPTION OF THE INVENTION

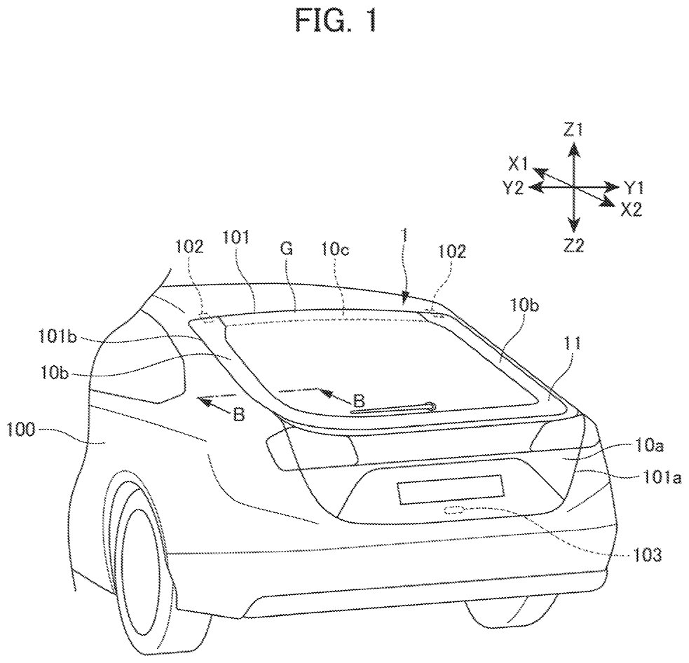

An embodiment of the present invention will now be described in detail with reference to the accompanying drawings. As illustrated in FIG. 1, a vehicle body 100 has a rear opening 101 at its rear. P rear gate 1 is attached, in an openable and closable manner, to the rear opening 101 via a pair of hinges 102, 102.

Note that, as for directions illustrated in the drawings, X1-X2 refers to a vehicle body front-rear direction. The X1 direction refers to the direction toward the front of the vehicle body 100, and the X2 direction refers to the direction toward the rear of the vehicle body 100. Y1-Y2 refers to a vehicle body width direction. When the vehicle body 100 is viewed from the rear, the Y1 direction refers to the direction toward the right of the vehicle body 100, and the Y2 direction refers to the direction toward the left of the vehicle body 100. Z1-Z2 refers to a vehicle body upward-downward direction. The Z1 direction refers to the upward direction with respect to the vehicle body 100, and the 22 direction refers to the downward direction with respect to the vehicle body 100.

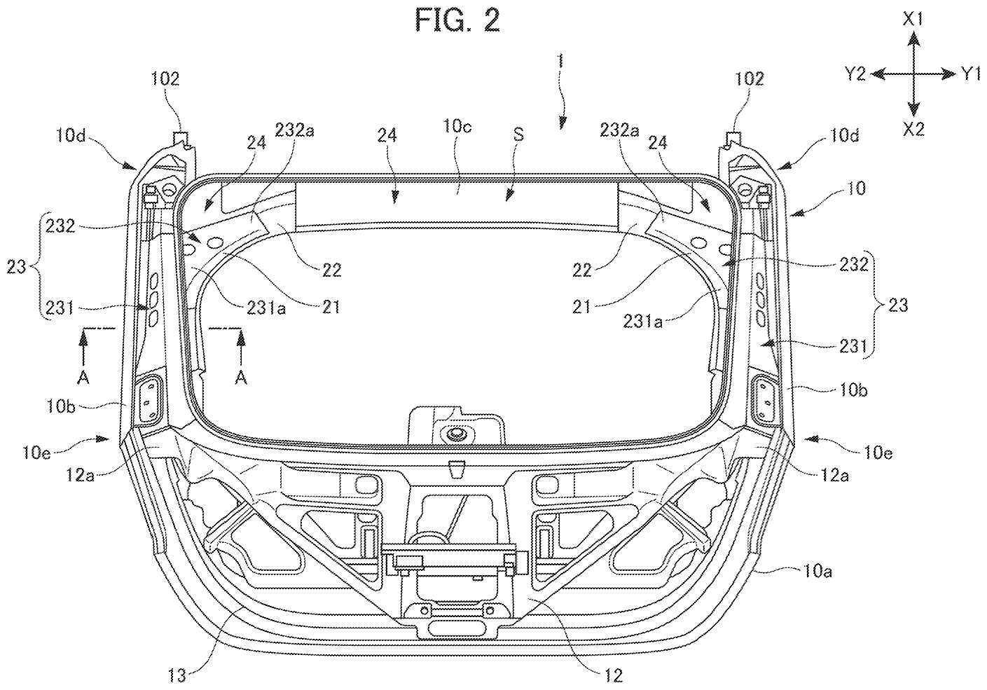

The rear gate 1 is an opening and closing member that opens and closes the rear opening 101 of the vehicle body 100. As illustrated in FIGS. 1 and 2, the rear gate 1 has: a rear end part 10a that closes a rear end opening 101a that is a portion of the rear opening 101; a pair of side parts 10b, 10b respectively extending from both ends, in the vehicle body width direction, of the rear end part 10a, toward the front of the vehicle body 100; and a front end part 10c coupling the pair of side parts 10b, 10b to each other at their ends adjacent to a vehicle body front side. An upper portion of the rear end part 10a, the pair of side parts 10b, 10b, and the front end part 10c form a window frame 10 extending along the four sides of the rear gate 1. A glass panel G is attached to the window frame 10.

As illustrated in FIGS. 1 to 3, the rear gate 1 according to the present embodiment includes an outer panel 11, a mid-panel 12, and an inner panel 13. The outer panel 11 is a resin panel that constitutes an outer surface of the rear gate 1. The mid-panel 12 is a metal member that is disposed between the outer panel 11 and the inner panel 13 and that constitutes a skeleton of the rear gate 1 together with the inner panel 13. The Inner panel 13 is a resin panel that constitute an inner surface of the rear gate 1. The outer panel 11 and the inner panel 13 extend over the rear end part 10a, both the side parts 10b, 10b, and the front end part 10c of the rear gate 1 to form a surface, facing a vehicle body outer side, of the window frame 10. The mid-panel 12 is disposed in the rear end part 10a of the rear gate 1. The rear gate 1 is light in weight and low in cost because it includes the outer panel 11 and the inner panel 13 that are each made of resin.

The rear gate 1 includes reinforcing members 2, 2 disposed on a side, facing a vehicle body inner side, of the outer panel 11. Specifically, the reinforcing members 2, 2 are disposed between the outer panel 11 and the inner panel 13, and are respectively arranged along both sides, in the vehicle body width direction, of the window frame 10 of the rear gate 1. Since the reinforcing members 2, 2 are substantially symmetrical in the vehicle body width direction, one of the reinforcing members 2 will be described in detail in the following description.

The reinforcing member 2 includes an outer reinforcing member 21 disposed adjacent the vehicle body outer side and an Inner reinforcing member 22 disposed adjacent to the vehicle body inner side. The outer reinforcing member 21 and the inner reinforcing member 22 are each formed by shaping a metal plate. Note that, as for the vehicle body outer side and the vehicle body inner side, in a state where the rear gate 1 closes the rear opening 101, the vehicle body outer side refers to a side distal from a position inside the vehicle body 100, and the vehicle body inner side refers to a side proximal to the position inside the vehicle body 100.

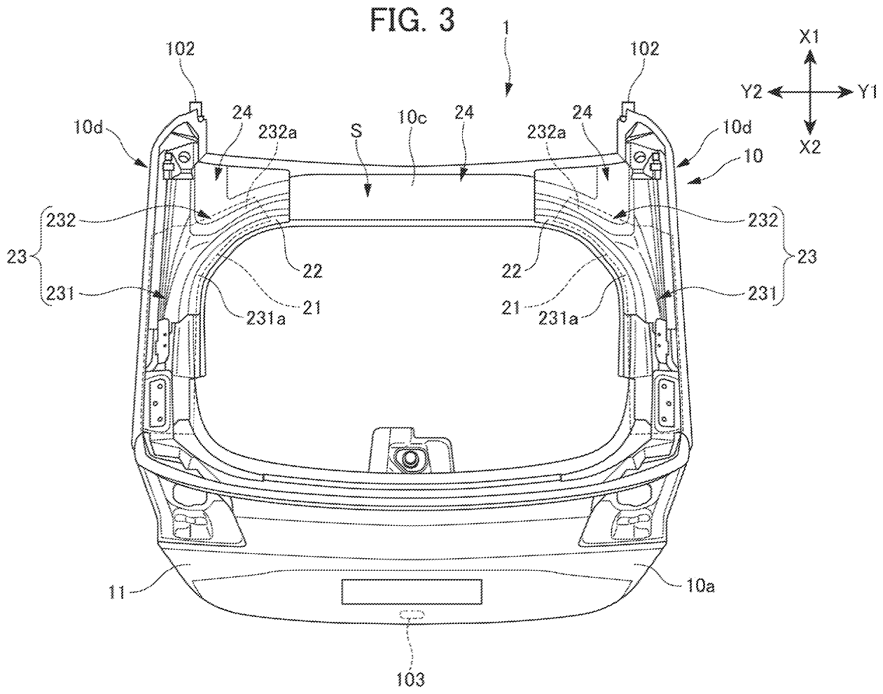

The outer reinforcing members 21 are respectively disposed on the side parts 10b, 10b of the rear gate 1, which correspond to both sides, in the vehicle body width direction, of the window frame 10. As illustrated in FIGS. 2 and 3, each outer reinforcing member 21 extends in the vehicle body front-rear direction along the corresponding side part 10b extending in the vehicle body front-rear direction, and has an end portion located adjacent to the vehicle body front side and bending in a dogleg shape inwardly in the vehicle body width direction toward the front end part 10c of the rear gate 1.

The inner reinforcing members 22 are respectively disposed on the side parts 10b, 10b of the rear gate 1, which correspond to both the sides, in the vehicle body width direction, of the window frame 10. Each inner reinforcing member 22 overlaps with, and is integrally fixed to the corresponding outer reinforcing member 21 by, for example, welding. As illustrated in FIGS. 2 and 3, like the outer reinforcing member 21, each inner reinforcing member 22 extends in the vehicle body front-rear direction along the corresponding side part 10b extending in the vehicle body front-rear direction, and has an end portion located adjacent to the vehicle body front side and bending in a dogleg shape inwardly in the vehicle body width direction toward the front end part 10c of the rear gate 1. At a position adjacent to the vehicle body front side, each inner reinforcing member 22 is disposed to protrude toward the vehicle body front side and inwardly in the vehicle body width direction, with respect to the corresponding outer reinforcing member 21.

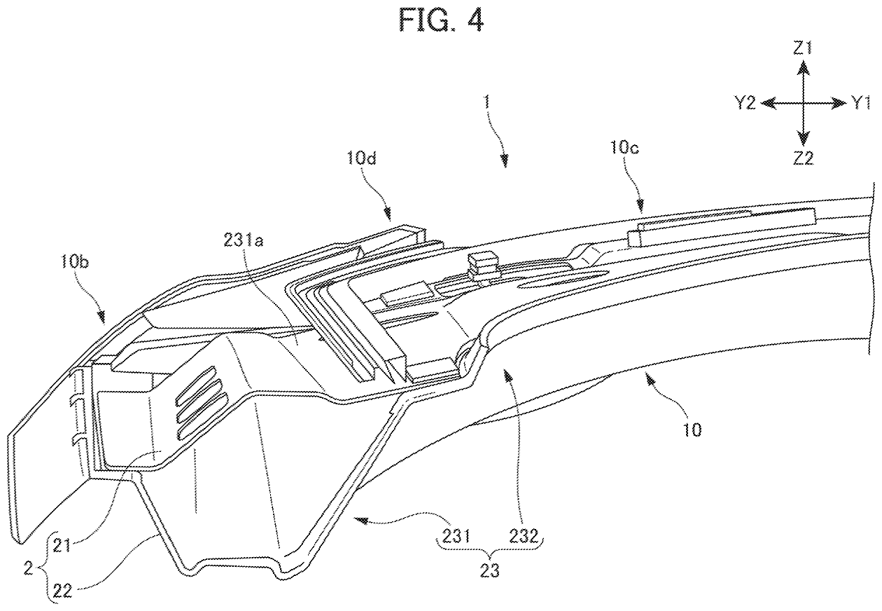

As illustrated in FIG. 4, the reinforcing member 2 has a closed section part 23 formed by the outer reinforcing member 21 and the inner reinforcing member 22 overlapping with each other. The closed section part 23 forms a closed space where a side facing the vehicle body upward direction is closed by the outer, reinforcing member 21, and a side facing the vehicle body downward direction is closed by the inner reinforcing member 22. Since the outer reinforcing member 21 and the inner reinforcing member 22 both extend in the vehicle body front-rear direction along the side part 10b and each have the end portion located adjacent to the vehicle body front side and bending inwardly in the vehicle body width direction, the closed section part 23 also extends in the vehicle body front-rear direction along the side part 10b, and has an end portion located adjacent to the vehicle body front side and bending inwardly in the vehicle body width direction.

Specifically, the closed section part 23 has, on the side part 10b, a front-rear closed section part 231 and an inclined closed section part 232. The front-rear closed section part 231 extends in the vehicle body front-rear direction. The inclined closed section part 232 extends from an end 231a, located adjacent to the vehicle body front side, of the front-rear closed section part 231, and inclines inwardly in the vehicle body width direction. That is, the closed section part 23 is disposed to extend from the side part 10b of the window frame 10 toward an end of the front end part 10c via a corner 10d, located adjacent to the vehicle body front side, of the window frame 10.

Since the outer reinforcing member 21 is smelter (shorter) than the inner reinforcing member 22, an open section part 24 having no closed section part is formed between the hinge 102 and a position closer to the vehicle body front side than the inclined closed section part 232. The open section part 24 is a portion which is on the window frame 10, and in which the outer reinforcing member 21 and the inner reinforcing members 22 are absent or only the inner reinforcing members 22 is present. In the rear gate i according to the present embodiment, the inner reinforcing member 22 has a portion lying adjacent to the vehicle body front side and bending slightly inwardly in the vehicle body width direction from the corner 10d of the window frame 10, and ends at a position Immediately after the bent portion. Therefore, the open section part 24 is also disposed in the front end part 10c of the window frame 10 so as to lie between inner ends 232a, 232a of the pair of inclined closed section part 232, 232 in the vehicle body width direction.

The reinforcing member 2 having the closed section part 23 as described above forms a hollow skeleton in the window frame 10 of the rear gate 1. This configuration increases the strength and stiffness of the side parts 10b, 10b and those of the corners 10d, 10d of the window frame 10 of the rear gate 1. In particular, the front-rear closed section parts 231 have an effect of reinforcing the rear gate 1 against a load to be applied between the hinges 102 and a striker 103 (see FIGS. 1 and 3) provided to the rear end part 10a when the rear gate 1 is opened or closed. The striker 103 is a means for locking onto the vehicle body 100. The inclined closed section parts 232 have an effect of reinforcing the rear gate 1 against stress concentrated at the corners 10d when the rear gate 1 is opened or closed. Furthermore, the reinforcing members 2 each have a hollow shape, and the open section parts 24 are provided between the hinges 102 and the inclined closed section parts 232. This configuration makes it possible to ensure strength and stiffness required for the rear gate 1, while reducing an increase in the weight and cost of the rear gate 1. Since the rear gate I is attached to the vehicle body 100 via the pair of hinges 102, 102, the strength and stiffness of the side lying adjacent to the vehicle body front side are ensured, thereby minimizing the risk of lack of strength and stiffness even though the open section parts 24 are provided.

The open section part 24 according to the present embodiment has a portion disposed between the inner ends 232a, 232a, in the vehicle body width direction, of the pair of inclined closed section part 232, 232. This configuration makes it possible to ensure the strength and stiffness required for the rear gate 1, and to utilize the open section part 24 to ensure an arrangement space S for a member (not illustrated) such as a harness in the window frame 10 of the rear gate 1.

The inclined closed section part 232 extends from the end 231a, located adjacent to the vehicle body front side, of the front-rear closed section part 231 to a position before the front end part 10c, which is a portion forming part of the window frame 10 located adjacent to the vehicle body front side and extending straight in the vehicle body width direction. That is, the inclined closed section part 232 extends via the corner 10d, located adjacent to the vehicle body front side, of the window frame 10. The corner 10d is a portion that is likely to be subjected to stress when the rear gate 1 is opened or closed, and is a portion for which strength and stiffness needs to be ensured. Disposing the inclined closed section parts 232 extending via the corners 10d of the window frame 10 makes it possible to ensure the strength and stiffness of the corners 10d of the window frame 10, which are likely to be subjected to stress when the rear gate 1 is opened or closed.

As illustrated in FIG. 2, the mid-panel 12 of the rear gate 1 has, as its portions, both ends 12a, 12a in the vehicle body width direction, which are respectively disposed at corners 10e, 10e of the window frame 10 that are located adjacent to the vehicle body rear side. Since the mid-panel 12 is made of metal, the corners 10e, 10e are reinforced by the mid-panel 12. Thus, it is possible to ensure the strength and stiffness of the corners 10e, 10e of the window frame 10, which are likely to be subjected to stress when the rear gate 1 is opened or closed.

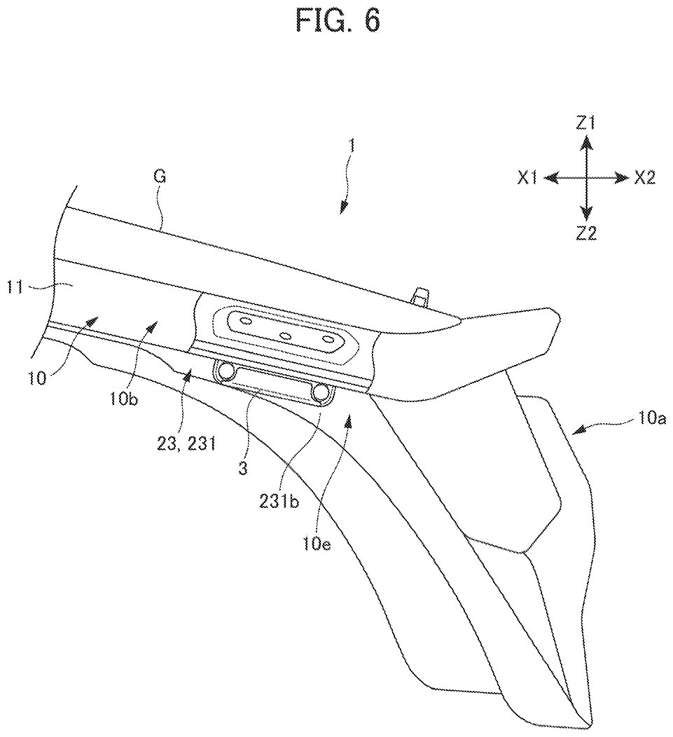

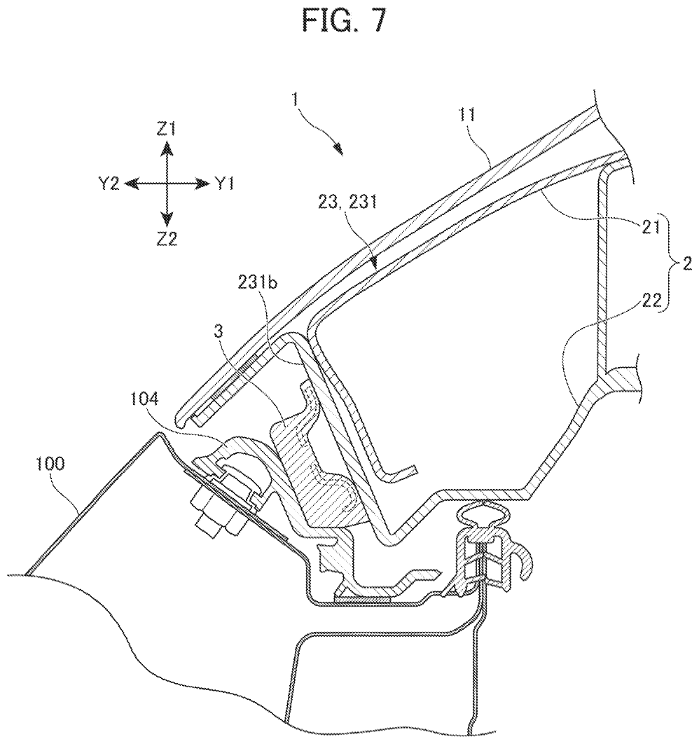

As illustrated in FIG. 6, a cushioning member 3 is provided on an outer side 231b, in the vehicle body width direction, of the front-rear closed section part 231. The position at which the cushioning member 3 is provided corresponds to the corner 10e, located adjacent to the vehicle body rear side, of the window frame 10 of the rear gate 1. The cushioning member 3 is made of, for example, rubber and has a substantially rectangular parallelepiped block shape. The cushioning member 3 is provided on each of both sides, in the vehicle body width direction, of the rear gate 1. As Illustrated in FIG. 7, the vehicle body 100 is provided with contact members 104 respectively provided at portions corresponding to the cushioning members 3. The contact members 104 are made of, for example, synthetic fibers and come into contact with the cushioning members 3 to receive a load of the rear gate 1 via the cushioning members 3 when the rear gate 1 closes the rear opening 101. The cushioning members 3 absorb impact when the cushioning members 3 come into contact with the contact members 104 provided on the vehicle body 100.

In the window frame 10 of the rear gate 1, the portions at which the cushioning members 3 are provided are likely to be subjected to stress when the rear gate 1 is opened or closed. Since the cushioning members 3 are provided to the front-rear closed section parts 231 of the reinforcing members 2, which have high strength and stiffness, it is possible to further ensure the strength and stiffness of the corners 10e, 10e, located adjacent to the vehicle body rear side, of the window frame 10, which are likely to be subjected to stress when the rear gate 1 is opened or closed.

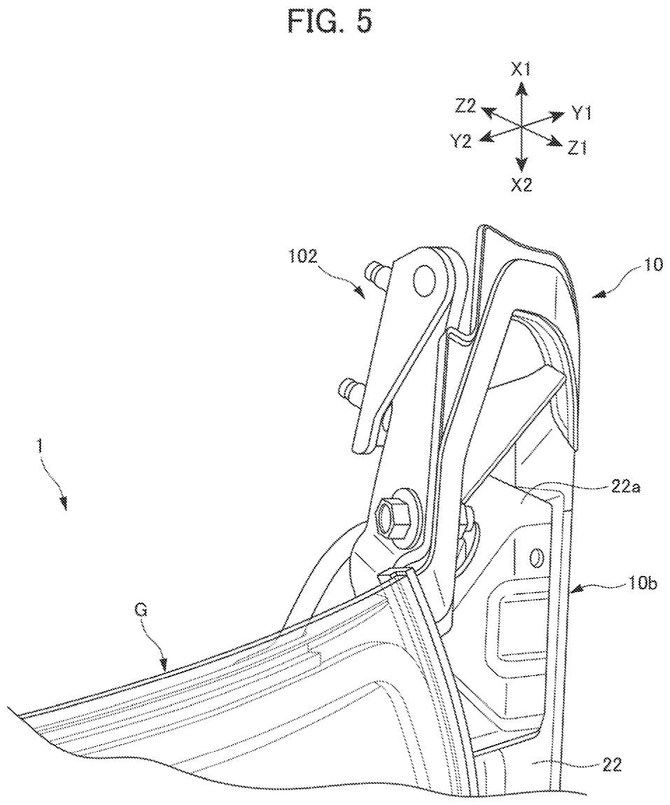

As illustrated in FIG. 5, the pair of hinges 102, 102 fixing the rear gate 1 to the vehicle body 100 are respectively attached to ends 22a, 22a, located adjacent to the vehicle body front side, of the inner reinforcing members 22, 22 of the reinforcing members 2, 2. Since the inner reinforcing members 22, 22 made of metal have high strength and stiffness, attaching the hinges 102, 102 to the inner reinforcing members 22, 22 makes it possible to reinforce the hinges 102, 102. This configuration allows the rear gate 1 to be opened and closed smoothly, and makes it possible to enhance the durability of mechanical parts provided for the opening and closing.

What is claimed is:

1. An opening and closing member attachable, in an openable and closable manner, to a rear opening of a vehicle body via a pair of hinges, the opening and closing member comprising: an outer panel disposed to face a vehicle body outer side; and
a reinforcing member dispossd on a side, facing a vehicle body inner side, of the outer panel,
the outer panel and the reinforcing member forming a window frame extending along four sides,
wherein the reinforcing member has closed section parts each formed by an outer reinforcing member disposed to face the vehicle body outer side and an inner reinforcing member disposed to face the vehicle body inner side,
wherein the closed section parts have, on both sides in a vehicle body width direction, a pair of front-rear closed section parts that extend in a vehicle body front-rear direction, and a pair of inclined closed section parts that respectively extend from ends, located adjacent to a vehicle body front side, of the pair of front-rear closed section parts, and that respectively incline inwardly in the vehicle body width direction, and
wherein open section parts are respectively provided between the pair of hinges and the pair of front-rear closed section parts.

2. The opening and closing member according to claim 1, wherein the open section parts are disposed between inner ends, in the vehicle body width direction, of the pair of inclined closed section parts.

3. The opening and closing member according to claim 1, wherein the pair of inclined closed section parts respectively extend from the ends, located adjacent to the vehicle body front side, of the pair of front-rear closed section parts to positions before a portion forming part of the window frame and extending straight in the vehicle body width direction.

4. The opening and closing member according to claim 1, further comprising:
a mid-panel provided on a side, lying adjacent to a vehicle body rear side and facing the vehicle body inner side, of the outer panel,
wherein the mid-panel has portions located at corners of the window frame that are adjacent to the vehicle body rear side.

5. The opening and closing member according to claim 1, further comprising:
cushioning members respectively provided at positions on outer sides, in the vehicle body width direction, of the pair of front-rear closed section parts, the positions corresponding to corners of the window frame that are located adjacent to a vehicle body rear side/the cushioning members coming into contact with parts on the vehicle body when the rear opening is closed.

6. The opening and closing member according to claim 1, wherein the pair of hinges are respectively attached to ends, located adjacent to the vehicle body front side, of the inner reinforcing members.
